(19) United States
(12) Patent Application Publication
(10) Pub. No.: US 2012/0177800 A1
(43) Pub. Date: Jul. 12, 2012

(54) Natural Mixed Sweetner

(76) Inventor: Michael T. Alexander, Oxford, CT (US)

(21) Appl. No.: 13/424,125

(22) Filed: Mar. 19, 2012

Related U.S. Application Data
(63) Continuation-in-part of application No. 12/661,533, filed on Mar. 18, 2010.
Application No. 12/661,533 is a continuation-in-part of application No. 12/661,689, filed on Mar. 18, 2010.

(51) Int. Cl. A23L 1/236

(52) U.S. Cl. 426/548

(57) ABSTRACT

A sweetener and a method for creating the sweetener is provided, wherein the sweetener includes sucrose, erythritol, dextrose, maltodextrin, and stevia extract. Additionally, the sweetener may include fructose. Additionally, a method for generating the sweetener is provided and includes adding about 120 ml of erythritol and about one (1) teaspoon of a combination of maltodextrin and stevia extract to a container containing about 120 ml of table sugar. The container is agitated to cause the table sugar and the combination of maltodextrin and stevia extract to combine and about 120 ml of dextrose and a second about one (1) teaspoon of a combination of maltodextrin and stevia extract is introduced into the container. The is re-agitating to cause the contents of the container to mix together.

### RELATED APPLICATIONS

This application is a continuation-in-part application of U.S. patent application Ser. No. 12/661,533, filed Mar. 18, 2010, titled “Novel Natural Mixed Sweetener” and is a continuation-in-part application of U.S. patent application Ser. No. 12/661,689, filed Mar. 18, 2010, titled “Novel Natural Mixed Sweetener,” the contents of both of which are incorporated by reference herein in their entireties.

### FIELD OF THE INVENTION

The present invention relates to sweeteners and more particularly to an all natural sweetener for use in food and drinks.

### BACKGROUND OF THE INVENTION

Sugar has been used for centuries to make candy and as a sweetener for other foods and drinks. Unfortunately, the use of sugar in foods has many disadvantages that are namely related to the health impact on consumers. One reason for this is that since the discovery of sugar its consumption grew at a high rate. For example, in 1700 the average person consumed about 4 pounds of sugar per year, while in 2009 the average person consumed almost 180 pounds per year. In order to make their products more palatable manufacturers of processed food and drink products add sugar (in various forms) into their products. As a result, the level of obesity has reached an all time high along with the related health problems associated with obesity. Another problem involves the effect sugar has on the human blood sugar levels. For example, the use of plain table sugar (say in coffee or tea) can cause human blood sugar levels to initially rise and then quickly drop. In some cases, the blood sugar levels can become low enough to cause symptoms of fatigue and confusion because the brain is no longer getting an adequate supply of sugar.

Accordingly, in response to the public's demand for more healthy foods, manufacturers of processed food and drink products have tried to address these health issues by developing and using sugar substitutes which may be natural or synthetic (the synthetic sweeteners are typically referred to as artificial sweeteners) in nature, but that have lower calories than sugar while duplicating the effects of sugar in taste. Some natural sugar substitutes include Brazzein, Curculin, Erythritol, Glycyrrhizin, Glycerol, Hydrogenated starch hydrolysates, Inulin, Isomalt, Sorbitol, Stevia and Lactito and some artificial sweeteners include Acesulfame potassium, Alitame, Aspartame, Saccharin, Sucralose, Salt of aspartame-acesulfame and Neotame. Unfortunately, these sugar substitutes come with their own set of problems. For example, both natural and artificial sugar substitutes, such as Saccharin, are thought by the public to be carcinogenic to humans.

Additionally, while current sugar substitutes provide a sweetening alternative commonly they have an off-flavor or bitter aftertaste, such as saccharin and aspartame. This is undesirable as it negatively affects the taste of the food/drink in which it is used.

### SUMMARY OF THE INVENTION

A sweetener is provided in accordance with one embodiment of the invention and includes sucrose, erythritol, dextrose, maltodextrin and stevia extract, wherein the sweetener includes about 32.43% of sucrose by volume ±15%, about 32.43% of erythritol by volume ±15%, about 32.43% of dextrose by volume ±15%, about 2.54% of maltodextrin by volume ±15%, and about 0.27% of stevia extract by volume ±15%.

A method for generating a sweetener is provided in accordance with one embodiment of the invention and includes adding about 120 ml of erythritol and a first about one (1) teaspoon of a combination of maltodextrin and stevia extract to a container containing about 120 ml of table sugar and then agitating the container to cause the table sugar and the combination of maltodextrin and stevia extract to combine. The method further includes introducing about 120 ml of dextrose and a second about one (1) teaspoon of a combination of maltodextrin and stevia extract to the container and re-agitating the container to cause the contents of the container to mix together.

A sweetener is provided in accordance with another embodiment of the invention and includes erythritol, dextrose, sucrose, fructose, maltodextrin, and stevia extract, wherein the sweetener includes about 33.33% of erythritol by volume ±15%, about 30.55% of dextrose by volume ±15%, about 16.67% of sucrose by volume ±15%, about 16.67% of fructose by volume ±15%, about 2.50% of maltodextrin by volume ±15%, and about 0.28% of stevia extract by volume ±15%.

A method for generating a sweetener in accordance with another embodiment of the invention is provided and includes adding about 110 ml of dextrose and a first about one (1) teaspoon of a combination of maltodextrin and stevia extract to a container containing about 120 ml of erythritol. The container is agitated to cause the erythritol and the combination of maltodextrin and stevia extract to combine and about 60 ml of sucrose, about 60 ml of fructose and a second about one (1) teaspoon of a combination of maltodextrin and stevia extract is introduced into the container. The container is re-agitated to cause the contents of the container to mix together.

### BRIEF DESCRIPTION OF THE DRAWINGS

FIG. 1 is an operational block diagram illustrating one embodiment of a method for combining ingredients to achieve the natural sweetener of the present invention.

FIG. 2 is an operational block diagram illustrating a second embodiment of a method for combining ingredients to achieve the natural sweetener of the present invention.

### DETAILED DESCRIPTION OF THE INVENTION

In accordance with the present invention, a unique and novel natural sweetener is disclosed and provided, where the sweetener has a taste similar to that of table sugar (aka, sucrose), but with no detectable aftertaste (or other flavor deviation) and with less calories than table sugar. When compared to table sugar, the natural sweetener of the present invention does not have a significant impact on blood sugar levels in humans. As such, this is particularly advantageous as the natural sweetener of the present invention may be suitable for use by humans that have type one diabetes, type two diabetes and/or hypoglycemia.

In accordance with a first embodiment of the invention, the natural sweetener is composed of Table sugar, Erythritol, Dextrose, Maltodextrin and Stevia Extract. These ingredients are present in the composition as shown in Table 1.0 below.

| Ingredient | Volume |
|---|---|
| Table Sugar | approximately 32.43% |
| Erythritol | approximately 32.43% |
| Dextrose | approximately 32.43% |
| Maltodextrin | approximately 2.54% |
| Stevia Extract | approximately 0.27% |

It is contemplated that the concentrations of ingredients listed above may be adjusted as desired by ±15%. It should be appreciated that the Glycemic Index of this sweetener is 54.

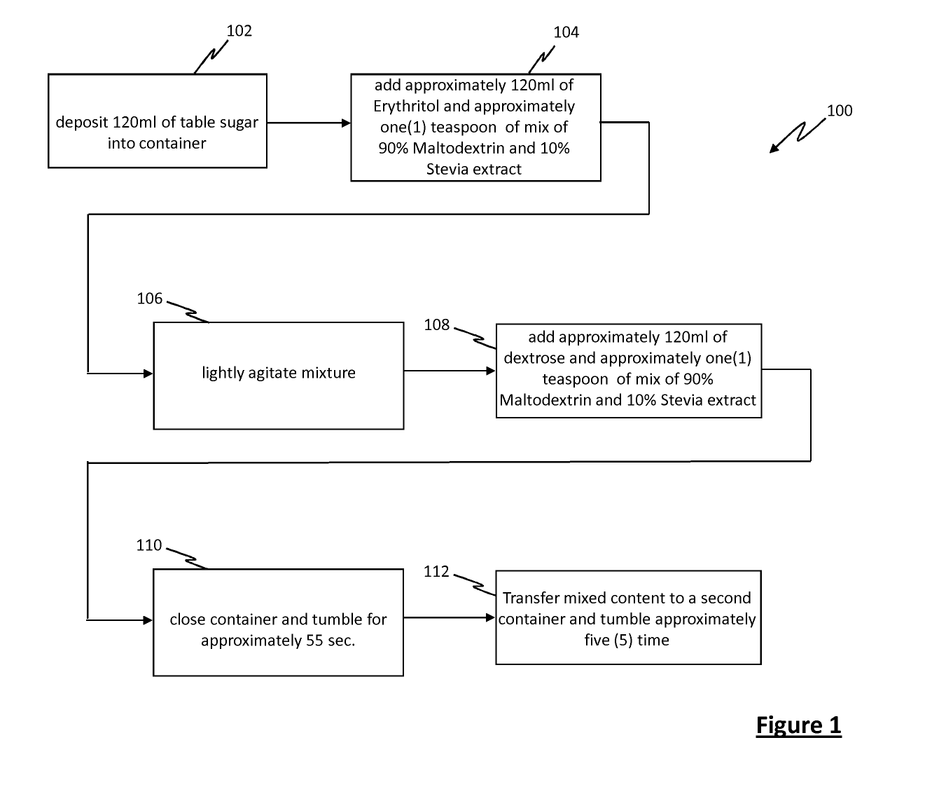

Referring to FIG. 1, an operational block diagram illustrating an exemplary embodiment of a method 100 for combining the above components to achieve the natural sweetener of the present invention is shown and includes depositing approximately 120 ml of Table Sugar into a container, as shown in operational block 102. To this, approximately 120 ml of Erythritol and approximately one (1) teaspoon of a mixture of 90% Maltodextrin and 10% Stevia is added, as shown in operational block 104, and the container is lightly agitated to combine the ingredients, as shown in operational block 106. This combination is then agitated. It should be appreciated that although in one embodiment the container is slid back and forth three times, any type of agitation suitable to the desired end purpose is contemplated. To this mixture, approximately 120 ml of dextrose is added along with approximately one (1) teaspoon of a mixture of 90% Maltodxtrin and 10% Stevia is added, as shown in operational block 108. The container is closed to prevent leakage and tumbled for approximately 55 seconds, as shown in operational block 110. The mixed contents of the container are transferred to a second container which is then closed to prevent leakage. This second container is tumbled and/or shaken approximately five (5) times, as shown in operational block 112.

In accordance with a second embodiment of the invention, the natural sweetener is composed of Erythritol, Dextrose, Sucrose, Fructose, Maltodextrin and Stevia Extract. These ingredients are present in the composition as shown in Table 2.0 below.

| Ingredient | By Volume |
|---|---|
| Erythritol | approximately 33.33% |
| Dextrose | approximately 30.55% |
| Sucrose | approximately 16.67% |
| Fructose | approximately 16.67% |
| Maltodextrin | approximately 2.50% |
| Stevia Extract | approximately 0.28% |

It is contemplated that concentrations of ingredients listed above may be adjusted as desired. It should be appreciated that the Glycemic Index of this sweetener is 47.

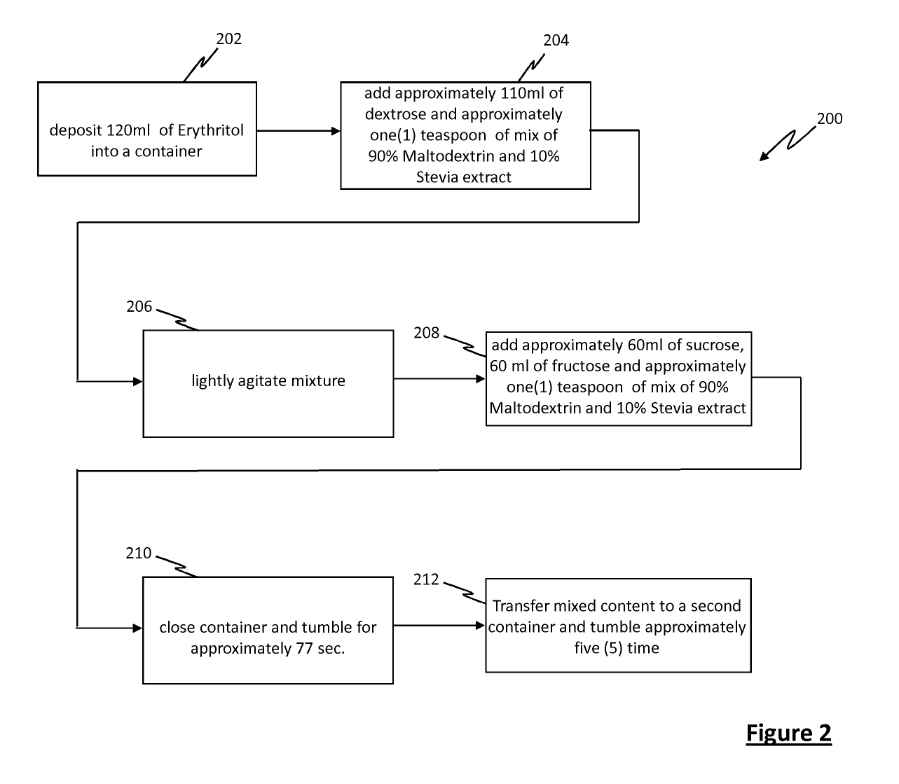

Referring to FIG. 2, an operational block diagram illustrating another embodiment of a method 200 for combining the above components to achieve the natural sweetener of the present invention is shown and includes depositing approximately 120 ml of Erythritol into a container, as shown in operational block 202. To this, approximately 110 ml of dextrose and approximately one (1) teaspoon of a mixture of 90% Maltodextrin and 10% Stevia is added, as shown in operational block 204, and the container is lightly agitated to combine the ingredients, as shown in operational block 206. It should be appreciated that although in one embodiment the container is slid back and forth three times, any type of agitation suitable to the desired end purpose is contemplated. Approximately 60 ml of sucrose and 60 ml of fructose is added along with approximately one (1) teaspoon of a mixture of 90% Maltodextrin and 10% Stevia to the mixture, as shown in operational block 208. The container is closed to prevent leakage and tumbled for approximately 77 seconds, as shown in operational block 210. The mixed contents of the container are transferred to a second container which is then closed to prevent leakage. This second container is tumbled and/or shaken approximately five (5) times, as shown in operational block 212.

In accordance with the present invention, the method 100, 200 of the present invention may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

As discussed briefly hereinabove, the Glycemic Indices of the sweeteners of the present invention is advantageously less than 55. As the Glycemic Index is a quantitative measure of the effects of the carbohydrates in a food on the blood sugar level of a person, this is an important characteristic. Basically, the GI estimates just how much each measure (i.e. gram) of available carbohydrate in a food raises a person's blood glucose level following consumption of the food relative to the glucose. As a comparative, glucose has a Glycemic Index of 100. As such, a lower Glycemic Index is desirable because it suggests a lower Glycemic response which typically relates to a lower insulin demand and thus, improved long-term blood glucose control. In fact, foods with Glycemic Index values of 55 or less are desired from a health perspective because they are broken down by the body into glucose more slowly than foods with higher Glycemic Index values. In fact, this is a critical factor in managing diabetes effectively. Accordingly, it is contemplated that the elements disclosed herein above with regards to the embodiments of the invention may be substituted with other elements with like characteristics. For example, Erythritol is a sugar alcohol and may be substituted with other sugar alcohols such as sorbitol, xylitol, etc. . . .

Moreover, the method of the present invention may be embodied in the form of a computer or controller implemented processes. The method of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A sweetener, comprising:
sucrose;
erythritol;
dextrose;
maltodextrin; and
stevia extract, wherein the sweetener includes about 32.43% of sucrose by volume ±15%, about 32.43% of erythritol by volume ±15%, about 32.43% of dextrose by volume ±15%, about 2.54% of maltodextrin by volume ±15%, and about 0.27% of stevia extract by volume ±15%.

2. The sweetener of claim 1, wherein about 32.43% of sucrose by volume includes the range of about 37.39% by volume and 27.56% by volume.

3. The sweetener of claim 1, wherein about 32.43% of erythritol by volume includes the range of about 37.39% by volume and 27.56% by volume.

4. The sweetener of claim 1, wherein about 32.43% of dextrose by volume includes the range of about 37.39% by volume and 27.56% by volume.

5. The sweetener of claim 1, wherein about 2.54% of maltodextrin by volume includes the range of about 2.92% by volume and 2.16% by volume.

6. The sweetener of claim 1, wherein about 2.54% of stevia extract by volume includes the range of about 0.31% by volume and 0.23% by volume.

7. A method for generating a sweetener, the method comprising:
adding about 120 ml of erythritol and a first about one (1) teaspoon of a combination of maltodextrin and stevia extract to a container containing about 120 ml of table sugar;
agitating the container to cause the table sugar and the combination of maltodextrin and stevia extract to combine;
introducing about 120 ml of dextrose and a second about one (1) teaspoon of a combination of maltodextrin and stevia extract to the container; and
re-agitating the container to cause the contents of the container to mix together.

8. The method of claim 7, wherein the combination of maltodextrin and stevia extract includes about 90% maltodextrin and about 10% stevia extract.

9. The method of claim 7, wherein adding includes generating the combination of maltodextrin and stevia extract prior to adding.

10. The method of claim 7, wherein agitating includes sliding the container in “a back and forth” fashion three times.

11. The method of claim 7, wherein re-agitating includes,
sealing the container;
tumbling the container for about 55 seconds to generate tumbled contents;
transferring the tumbled contents into a second container; and
agitating the second container to generate mixed contents.

12. The method of claim 11, wherein agitating the second container includes,
sealing the second container; and
at least one of,
tumbling the second container about five (5) times; and
shaking the second container about five (5) times.

13. A sweetener, comprising:
erythritol;
dextrose;
sucrose;
fructose;
maltodextrin; and
stevia extract, wherein the sweetener includes about 33.33% of erythritol by volume ±15%, about 30.55% of dextrose by volume ±15%, about 16.67% of sucrose by volume ±15%, about 16.67% of fructose by volume ±15%, about 2.50% of maltodextrin by volume ±15%, and about 0.28% of stevia extract by volume ±15%.

14. The sweetener of claim 13, wherein about 33.33% of erythritol by volume includes the range of about 38.32% by volume and 28.33% by volume.

15. The sweetener of claim 13, wherein about 30.55% of dextrose by volume includes the range of about 35.13% by volume and 25.96% by volume.

16. The sweetener of claim 13, wherein about 16.67% of sucrose by volume includes the range of about 19.17% by volume and 14.16% by volume.

17. The sweetener of claim 13, wherein about 16.67% of fructose by volume includes the range of about 19.17% by volume and 14.16% by volume.

18. The sweetener of claim 13, wherein about 2.50% of maltodextrin by volume includes the range of about 2.87% by volume and 2.12% by volume.

19. The sweetener of claim 13, wherein about 0.28% of stevia extract by volume includes the range of about 0.32% by volume and 0.23% by volume.

20. A method for generating a sweetener, the method comprising:
adding about 110 ml of dextrose and a first about one (1) teaspoon of a combination of maltodextrin and stevia extract to a container containing about 120 ml of erythritol;
agitating the container to cause the erythritol and the combination of maltodextrin and stevia extract to combine;
introducing about 60 ml of sucrose, about 60 ml of fructose and a second about one (1) teaspoon of a combination of maltodextrin and stevia extract to the container; and
re-agitating the container to cause the contents of the container to mix together.
